(19) United States
(12) Patent Application Publication
(10) Pub. No.: US 2017/0090226 A1
(43) Pub. Date: Mar. 30, 2017

(54) LIQUID CRYSTAL DISPLAY

(71) Applicant: Samsung Display Co., Ltd., Yongin-city (KR)

(72) Inventors: Seung Hee OH, Goyang-si (KR); Sung Hwan BAE, Asan-si (KR); Joo Lark SON, Suwon-si (KR); Joon Hyeong KIM, Cheonan-si (KR)

(21) Appl. No.: 15/042,338

(22) Filed: Feb. 12, 2016

(30) Foreign Application Priority Data
Sep. 30, 2015 (KR) 10-2015-0137364

(51) Int. Cl. G02F 1/1337; G02F 1/1339; G02F 1/1335

(52) U.S. Cl. CPC G02F 1/1337; G02F 1/133512; G02F 1/133514; G02F 1/1339

(57) ABSTRACT

A liquid crystal display includes a first substrate including an active area in which an image is displayed and a non-active area around the active area and in which an image is not displayed; a color filter on the first substrate and in the active area thereof; a first blocking member on the first substrate and in the non-active area thereof; and a first alignment layer on the color filter and in the active area. The first blocking member includes a first color layer in the non-active area; a first light-blocking part on the first color layer and overlapping the first color layer; and a first spacer on the first light-blocking part and overlapping the first color layer and the first light-blocking part.

This application claims priority to Korean Patent Application No. 10-2015-0137364 filed on Sep. 30, 2015, and all the benefits accruing therefrom under 35 U.S.C. §119, the contents of which in their entirety are herein incorporated by reference.

### BACKGROUND

1. Field

The invention relates to a flat panel display, and more particularly, to a liquid crystal display (“LCD”).

2. Description of the Related Art

Liquid crystal displays (“LCDs”) are one of the most widely used types of flat panel displays. In an LCD, voltages are applied to electrodes disposed in two display substrates, which face each other, so as to rearrange liquid crystal molecules of a liquid crystal layer, thereby controlling the amount of light that transmits through the liquid crystal layer.

Generally, an alignment layer which determines an initial alignment direction of liquid crystal molecules is disposed on a surface of each of the two display substrates of the LCD. The alignment layer is typically formed by ejecting an alignment solution, which contains an alignment solid, onto the surface of each of the two display substrates such as using an inkjet printing method, and drying the alignment solution. However, the alignment solution ejected using the inkjet printing method may continuously spread toward a non-active area of the LCD and thus affect a sealing member of the LCD which bonds the two display substrates together. Accordingly, where the sealing member is affected by the spread of the alignment solution, adhesion of the two display substrates to each other is undesirably reduced, thereby deteriorating the display quality of the LCD.

### SUMMARY

One or more exemplary embodiment of the invention provide a liquid crystal display (“LCD”) having a relatively slim bezel and improved display quality due to the increased adhesion of two display substrates to each other.

However, the invention is not restricted to the exemplary embodiments set forth herein. The above and other features of the invention will become more apparent to one of ordinary skill in the art to which the invention pertains by referencing the detailed description of the invention given below.

According to an exemplary embodiment of the invention, a liquid crystal display is provided. The liquid crystal display includes a first substrate which includes an active area in which an image is displayed and a non-active area disposed around the active area and in which an image is not displayed; a color filter on the first substrate and in the active area thereof; a first blocking member on the first substrate and in the non-active area thereof; and a first alignment layer on the color filter and in the active area. The first blocking member includes a first color layer in the non-active area; a first light-blocking part on the first color layer and overlapping the first color layer; and a first spacer on the first light-blocking part and overlapping the first color layer and the first light-blocking part.

The first color layer may be defined by a stack of color layers having different colors from each other. The first color layer in the non-active area and the color filter in the active area may be in a same layer among layers disposed on the first substrate.

Also, the liquid crystal display may further include a second blocking member on the first substrate and in the active area thereof, the second blocking member spaced apart from the first blocking member in the non-active area. The second blocking member may include a second color layer in the non-active area; a second light-blocking part on the second color layer and overlapping the second color layer; and a second spacer on the second light-blocking part and overlapping the second color layer and the second light-blocking part. The second color layer may be defined by a stack of color layers having different colors from each other. The second color layer in the non-active area may be in a same layer as the color filter in the active area and the first color layer in the non-active area.

Also, the second blocking member may include a second color layer in the non-active area. The second color layer may be defined by a stack of color layers having different colors from each other.

Also, the first blocking member and the second blocking member disposed in the non-active area of the first substrate may have a bar shape, a bar shape from which protrusions extend, a broken line shape or a ladder shape.

Also, the LCD may further include a second substrate facing the first alignment layer disposed on the first substrate, the second substrate including an active area and a non-active area respectively corresponding to the active area and the non-active area of the first substrate; a third blocking member on the second substrate in the non-active area thereof; and a second alignment layer on the second substrate and in the active area thereof. The third blocking member may include a third color layer which is in the non-active area of the second substrate and adjacent to the active area of the second substrate and has one color.

Also, the LCD may further include a fourth blocking member on the second substrate and in the non-active area thereof, the fourth blocking member spaced apart from the third blocking member. The fourth blocking member may include a fourth color layer having one color. In a top plan view, the third blocking member and the fourth blocking member in the non-active area of the second substrate may have a bar shape, a bar shape from which protrusions extend, a broken line shape or a ladder shape. The first blocking member and the second blocking member in the non-active area of the first substrate may be disposed opposite to the third blocking member and the fourth blocking member in the non-active area of the second substrate, and in a direction from the active area to the non-active area in a top plan view, the third blocking member may be between the first blocking member and the second blocking member.

Also, the first substrate and the second substrate may be bonded together by a sealing member. The sealing member may be in the non-active area of the first substrate or the second substrate. In a direction from the active area to the non-active area in a top plan view, the first blocking member and the second blocking member may each be disposed between the active area of the first substrate and the sealing member. The second blocking member may be disposed closer to the sealing member than the first blocking member. The second blocking member may partially overlap the sealing member.

### BRIEF DESCRIPTION OF THE DRAWINGS

The above and other features of the invention will become more apparent by describing in detail exemplary embodiments thereof with reference to the attached drawings, in which:

FIG. 1 is a schematic exploded perspective view of an exemplary embodiment of a liquid crystal display (“LCD”) according to the invention;

FIG. 2 is a schematic top plan view of the LCD in FIG. 1;

FIG. 3 is a cross-sectional view of the LCD, taken along line I-I′ of FIG. 2;

FIG. 4 is a cross-sectional view of another exemplary embodiment of an LCD according to the invention, taken along line I-I′ of FIG. 2;

FIG. 5 is a cross-sectional view of still another exemplary embodiment of an LCD according to the invention, taken along line I-I′ of FIG. 2;

FIGS. 6 through 8 are enlarged top plan views of exemplary embodiments of area ‘A’ of FIG. 2 according to the invention;

FIG. 9 is a schematic top plan view of yet another exemplary embodiment of an LCD according to the invention; and

FIG. 10 is a cross-sectional view of the LCD taken along line II-II′ of FIG. 9.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

In a liquid crystal display (“LCD”), to reduce or effectively prevent alignment solution from affecting a sealing member, the sealing member may be placed at a relatively large distance from an active area of the LCD. Where the sealing member is placed at the relatively large distance from the active area, the width of the non-active area may be undesirably increased. Consequently, where the width of the non-active area increases, a width of a bezel of the LCD cannot be reduced.

In this regard, a dam may be disposed between the active area and the sealing member in order to reduce or effectively prevent the alignment solution from spreading to the sealing member. Generally, in a method of manufacturing an LCD, the dam may be formed by a same process and/or by a same material used when a color filter, a color spacer and/or a light-blocking member of the LCD is patterned.

When the color filter and the light-blocking member are disposed in different display substrates, an alignment error can occur between the color filter and the light-blocking member or between a pixel electrode and the light-blocking member. To reduce or effectively prevent the alignment error, a structure in which the light-blocking member, the pixel electrode and the color filter are disposed in the same display substrate of the LCD has been suggested.

If the light-blocking member, the pixel electrode and the color filter are disposed in the same substrate as in the above-suggested structure, a level of the dam (e.g., the level to which layers of the dam are stacked within the display substrate) is raised as compared with a conventional dam, and the raised level of the dam lowers a step height of the dam.

Accordingly, where the step height defined by the dam is decreased, the alignment solution frequently overflows the dam and spreads to the sealing member, resulting in a reduction in the adhesion of the two display substrates to each other. The reduced adhesion of the two display substrates to each other deteriorates the display quality of the LCD.

Hereinafter, exemplary embodiments of the invention will be described with reference to the attached drawings.

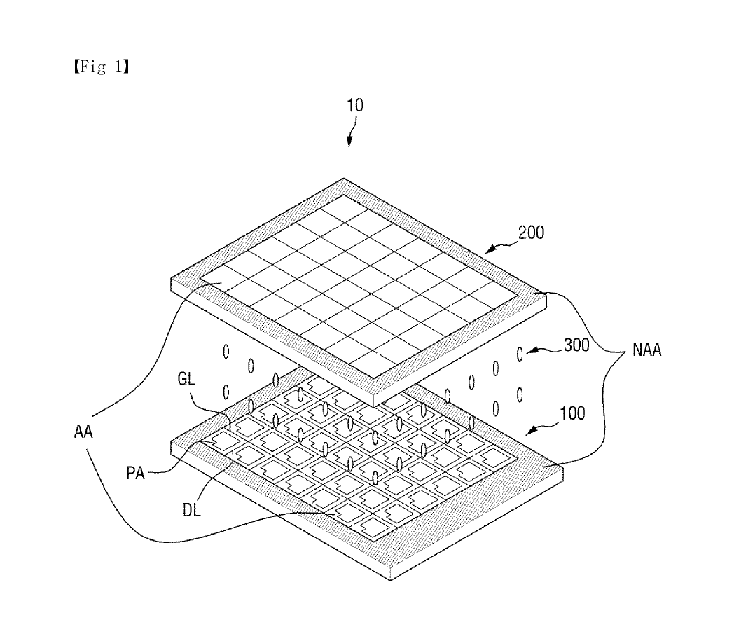

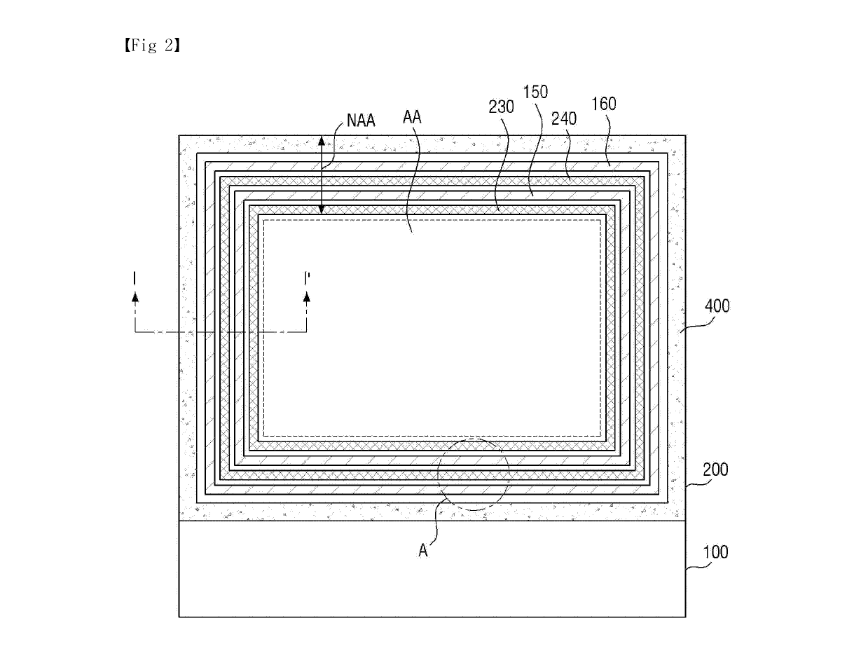

FIG. 1 is a schematic exploded perspective view of an exemplary embodiment of an LCD 10 according to an embodiment of the invention. FIG. 2 is a schematic top plan view of the LCD 10.

Referring to FIG. 1, the LCD 10 includes a first display substrate 100, a second display substrate 200 which faces the first display substrate 100, and a liquid crystal layer 300 which is interposed between the first display substrate 100 and the second display substrate 200.

The first display substrate 100 may include a data line DL provided in plural, a gate line GL provided in plural, and a pixel area PA provided in plural, on a first base substrate 110. The pixel areas PA may be defined by the data lines DL and the gate lines GL, but the invention is not limited thereto. An area in which the pixel areas PA are disposed may be referred to as an active area AA, and an area located around the active area AA may be referred to as a non-active area NAA.

The second display substrate 200 may be coupled to the first display substrate 100 to face the first display substrate 100. Like the first display substrate 100, the second display substrate 200 may include an active area AA and a non-active area NAA which correspond to the active area AA and the non-active area NAA of the first display substrate 100, respectively.

The active area AA may be defined by the respective pixel areas PA and regions between adjacent pixel area PA of a display substrate as indicated in FIG. 2, while the non-active area may be defined by a region excluding the above-described active area AA. An image may be displayed in the active area AA while an image is not displayed in the non-active area NAA.

The liquid crystal layer 300 may include a plurality of liquid crystal molecules which are disposed in the active area AA of each of the first display substrate 100 and the second display substrate 200 and have dielectric anisotropy. The liquid crystal molecules may be vertically aligned liquid crystal molecules which are arranged in a direction perpendicular to the first display substrate 100 and the second display substrate 200. When an electric field is formed between the first display substrate 100 and the second display substrate 200, the liquid crystal molecules may rotate in a certain direction, thereby transmitting or blocking light. In the illustrated exemplary embodiment, the liquid crystal molecules included in the liquid crystal layer 300 are described as vertically aligned liquid crystal molecules. However, the invention is not limited thereto, and the liquid crystal molecules can also be horizontally aligned liquid crystal molecules according to the disposition of field generating electrodes within the LCD.

The first display substrate 100 and the second display substrate 200 may be bonded together by a sealing member 400 as illustrated in FIG. 2.

The sealing member 400 may be disposed in the non-active area NAA of each of the first display substrate 100 and the second display substrate 200 to surround the active area AA and be interposed between the first display substrate 100 and the second display substrate 200. The sealing member 400 bonds the first display substrate 100 and the second display substrate 200 together.

In the non-active area NAA of each of the first display substrate 100 and the second display substrate 200, a first blocking member 150, a second blocking member 160, a third blocking member 230 and a fourth blocking member 240 may be disposed in an area between the sealing member 400 and the active area AA. The first blocking member 150, the second blocking member 160, the third blocking member 230 and the fourth blocking member 240 will be described in detail later.

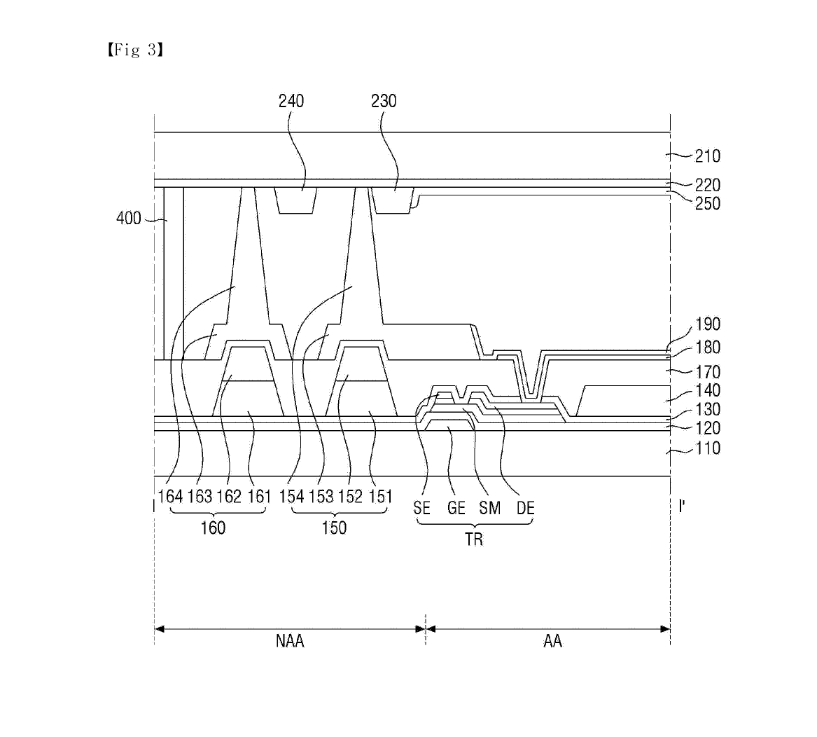

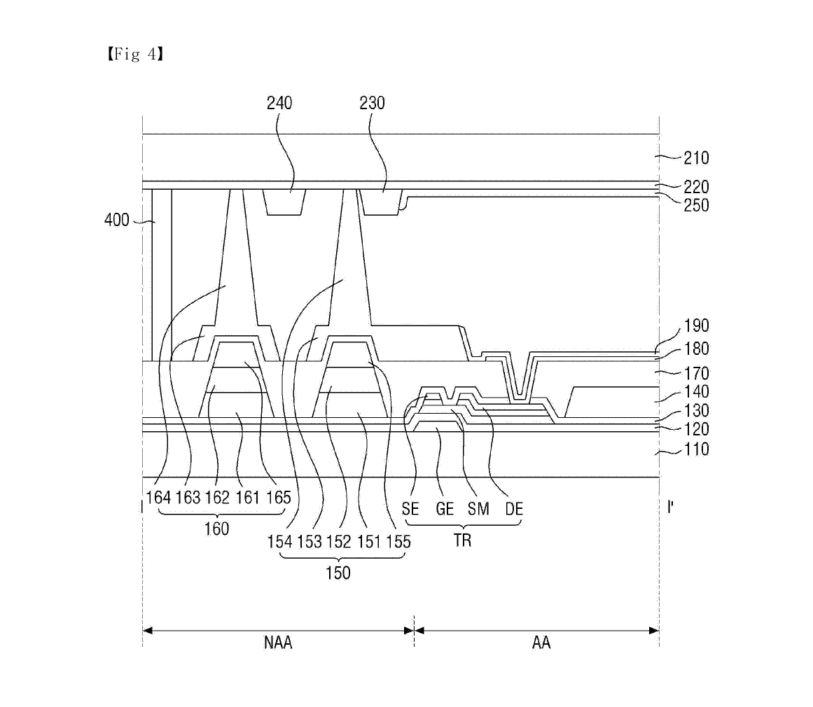

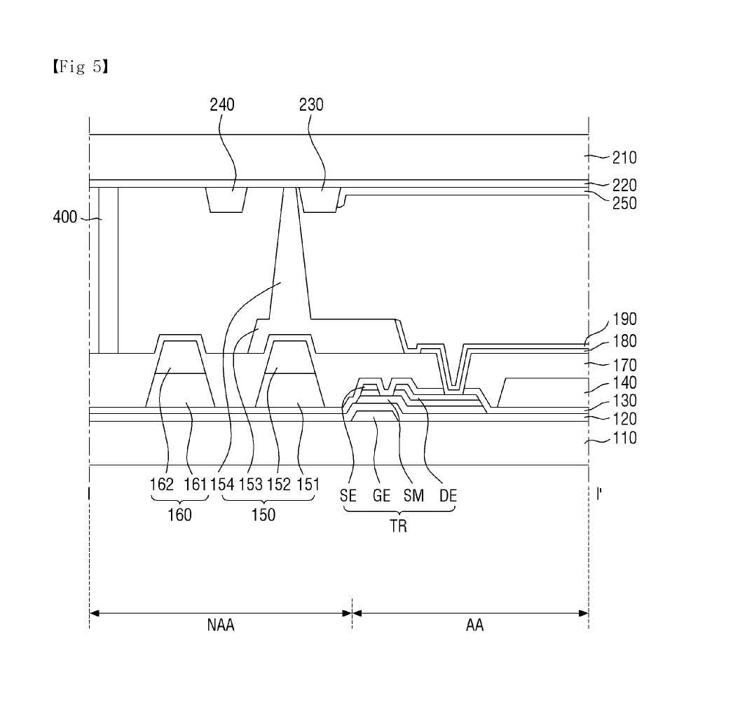

FIG. 3 is a cross-sectional view of the LCD, taken along line I-I′ of FIG. 2. FIG. 4 is a cross-sectional view of another exemplary embodiment of an LCD according to the invention, taken along line I-I′ of FIG. 2. FIG. 5 is a cross-sectional view of still another exemplary embodiment of an LCD according to the invention, taken along line I-I′ of FIG. 2.

Referring to FIG. 3, the LCD 10 according to the illustrated exemplary embodiment of the invention may include the first display substrate 100 and the second display substrate 200 as described above.

The first display substrate 100 may include the first base substrate 110, a switching device TR (e.g., a thin-film transistor (“TFT”)), a first insulating layer 120, a second insulating layer 130, a color filter 140, the first blocking member 150, the second blocking member 160, a third insulating layer 170, a pixel electrode 180 and a first alignment layer 190.

The first base substrate 110 may include or be made of an insulating material such as transparent glass, quartz, ceramic, silicon or transparent plastic. In some exemplary embodiments, the first base substrate 110 may include or be made of a flexible material.

The switching device TR may be disposed in the active area AA of the first base substrate 110. The switching device TR may include a gate electrode GE, a semiconductor layer SM, a source electrode SE and a drain electrode DE.

The gate electrode GE may be disposed on the first base substrate 110 and connected to a gate line GL (refer to FIG. 1). The gate electrode GE and the gate line GL may include a same material as each other and be disposed in a same layer as each other in the first display substrate 100 among layers thereof disposed on the first base substrate 110. The gate electrode GE and the gate line GL may include or be made of aluminum (Al)-based metal such as aluminum and an aluminum alloy, silver (Ag)-based metal such as silver and a silver alloy, copper (Cu)-based metal such as copper and a copper alloy, molybdenum (Mo)-based metal such as molybdenum and a molybdenum alloy, chrome (Cr), titanium (Ti), or tantalum (Ta). In addition, the gate electrode GE and the gate line GL may have a single layer structure, or a multilayer structure composed of two conductive layers (not illustrated) with different physical characteristics. In an exemplary embodiment of a multilayer structure, for example, one of the two conductive layers may include or be made of aluminum-based metal, silver-based metal or copper-based metal. The other one of the conductive layers may include or be made of molybdenum-based metal, chrome, titanium, or tantalum. In an exemplary embodiment, the multilayer structure may include a chrome lower layer and an aluminum upper layer or an aluminum lower layer and a molybdenum upper layer. However, the invention is not limited thereto, and the gate electrode GE and gate line GL can be made of various metals and conductors.

The semiconductor layer SM may be disposed on the gate electrode GE with the first insulating layer 120 interposed therebetween. A portion of the semiconductor layer SM may overlap the gate electrode GE. The semiconductor layer SM may include or be made of, e.g., hydrogenated amorphous silicon or polycrystalline silicon.

The source electrode SE may be disposed on the semiconductor layer SM and partially overlap the gate electrode GE. The source electrode SE may be connected to a data line DL (refer to FIG. 1) and protrude from the data line DL. The drain electrode DE may be disposed on the semiconductor layer SM to be separated from the source electrode SE and partially overlap the gate electrode GE. The source electrode SE, the data line DL and the drain electrode DE may include a same material as each other and be disposed in a same layer as each other in the first display substrate 100 among layers thereof disposed on the first base substrate 110. The source electrode SE and the drain electrode DE may include or be made of a metal, such as copper, molybdenum, tungsten, chrome or titanium, or an alloy including at least one of the above metals.

The first insulating layer 120 may be disposed on the first base substrate 110 in the active area AA and the non-active area NAA. The first insulating layer 120 may be interposed between the gate electrode GE and the semiconductor layer SM to electrically insulate the gate electrode GE from the semiconductor layer SM. The first insulating layer 120 may include be made of an insulating material such as silicon nitride or silicon oxide.

The second insulating layer 130 may be disposed on the first insulating layer 120 to cover the source electrode SE and the drain electrode DE. The second insulating layer 130 may be disposed on the first base substrate 110 in the active area AA and the non-active area NAA. The second insulating layer 130 may include a contact hole defined therein at which the drain electrode DE and the pixel electrode 180 may be to be electrically connected to each other. The second insulating layer 130 may include or be made of an insulating material such as silicon nitride or silicon oxide.

The color filter 140 may be disposed on the second insulating layer 130 to correspond to a pixel area PA of the active area AA. The color filter 140 may be provided in plural and one or more color filter 140 may be disposed to respectively correspond to the pixel areas PA of the active area AA. The color filter 140 is designed to add a color to light that transmits through the liquid crystal layer 300. The color filter 140 may include a red, a green and/or a blue color filter. The color filter 140 may include an organic material which defines a color of the color filter 140.

The first blocking member 150 may be disposed on the second insulating layer 130. The first blocking member 150 may include a first color layer 151, a second color layer 152, a first light-blocking part 153 and a first spacer 154. Here, the third insulating layer 170 may be interposed between the first and second color layer 151 and 152 of the first blocking member 150 and the first light-blocking part 153 and the first spacer 154 of the first blocking member 150.

The first color layer 151 may be disposed inn the non-active area NAA of the first base substrate 110. In an exemplary embodiment of manufacturing the LCD 10, the first color layer 151 and may be formed at the same time as the color filter 140. Where plural color filters 140 are formed having different colors from each other, the first color layer 151 may have a color of the first or second color filter 140. In an exemplary embodiment, if a color filter 140 firstly formed has a first color, the first color layer 151 may have the first color. The first color layer 151 may include a same material as the color filter 140 and be disposed in a same layer as the color filter 140 of the first display substrate 100 among layers thereof disposed on the first base substrate 110.

For reference, in an exemplary embodiment of manufacturing the LCD 10, the color filter 140 may be formed using a printing method such as an inkjet printing method. The color filter 140 having a blue color may be formed in some of the pixel areas PA which produce blue light. Then, the color filter 140 having a red color may be formed in some of the pixel areas PA which produce red light. Next, the color filter 140 having a green color may be formed in some of the pixel areas PA which produce green light. In other words, the red, green and blue color filters 140 may be formed not simultaneously but sequentially, but the invention is not limited thereto.

The second color layer 152 may be located in the non-active area NAA of the first base substrate 110. The second color layer 152 may be disposed on the first color layer 151 to overlap the first color layer 151, that is, may be stacked on the first color layer 151. The second color layer 152 may have a different color from that of the first color layer 151. In an exemplary embodiment of manufacturing the LCD 10, the first color layer 151, the second color layer 152 in the non-active area NAA may be formed when the color filter 140 is formed in the active area AA. Where plural color filters 140 are formed having different colors from each other, if a color filter 140 firstly formed has the first color, the second color layer 152 may have a second color or a third color each different from the first color. In other words, the first color layer 151 and the second color layer 152 may have different colors from each other.

The first light-blocking part 153 may partially overlap the switching device TR of the active area AA and overlap both the first color layer 151 and the second color layer 152 of the non-active area NAA.

In a conventional LCD, a color filter and a light-blocking member are disposed in different display substrates. Therefore, an alignment error can occur between the color filter and the light-blocking member or between a pixel electrode and the light-blocking member. To reduce or effectively prevent the alignment error, in the illustrated exemplary embodiment, the first light-blocking part 153 which blocks light, the pixel electrode 180 and the color filter 140 are placed in the same display substrate. In addition, the first light-blocking part 153 in the first display substrate 100 may be placed to correspond to the third blocking member 230 disposed in the second display substrate 200. The first light-blocking part 153 may include be made of a light-blocking material to block light that is unnecessary for formation of an image displayed in the active area AA.

The first spacer 154 may be disposed on the first light-blocking part 153 and partially overlap each of the first color layer 151, the second color layer 152 and the first light-blocking part 153. The first spacer 154 may maintain a cell gap between the first display substrate 100 and the second display substrate 200. In an exemplary embodiment of manufacturing the LCD 10, the first spacer 154 may reduce or effectively prevent an alignment solution disposed in the active area AA from overflowing to the sealing member 400.

In the illustrated exemplary, the first light-blocking unit 153 and the first spacer 154 include or are made of the same material and are formed integrally with each other. However, the invention is not limited thereto. Portions of one of the first light-blocking unit 153 and the first spacer 154 may define the other of the first light-blocking unit 153 and the first spacer 154.

As described above, among plural color layers, the first blocking member 150 illustrated in FIG. 3 includes the first and second color layers 151 and 152 only. However, in exemplary embodiments, the first blocking member 150 can include a first color layer 151, a second color layer 152 and a fifth color layer 155 as illustrated in FIG. 4. In other words, for color layers. The first blocking member 150 may include one more color layer than what is illustrated in FIG. 3. More specifically, the first color layer 151 may be disposed on the second insulating layer 130, the second color layer 152 may be disposed on the first color layer 151, and the fifth color layer 155 may be disposed on the second color layer 152. In addition, the first color layer 151, the second color layer 152 and the fifth color layer 155 of the first blocking member 150 illustrated in FIG. 4 may be stacked to have different colors from each other. In an exemplary embodiment, for example, when the first color layer 151 is blue, the second color layer 152 may be red, and the fifth color layer 155 may be green. In an exemplary embodiment of manufacturing the LCD 10, the fifth color layer 155 may also be formed at the same time as the color filter 140 as described above.

The second blocking member 160 may be located in the non-active area NAA of the first base substrate 110 and disposed on the second insulating layer 130 to be separated from the first blocking member 150 by a predetermined distance. More specifically, the second blocking member 160 may be disposed between the first blocking member 150 and the sealing member 400 in the non-active area NAA. The second blocking member 160 may include a third color layer 161, a fourth color layer 162, a second light-blocking portion 163 and a second spacer 164. Here, the third insulating layer 170 may be interposed between the third color layer 161 and the fourth color layer 162 of the second blocking member 160 and the second light-blocking part 163 and the second spacer 164 of the second blocking member 160.

In an exemplary embodiment of manufacturing the LCD 10, the third color layer 161 and the fourth color layer 162 of the second blocking member 160 may be formed when the color filter 140 in the active area AA and the first and second color layers 151 and 152 of the first blocking member 150 in the non-active area AA are formed. The second light-blocking part 163 and the second spacer 164 of the second blocking member 160 may also be formed when the first light-blocking part 153 and the first spacer 154 of the first blocking member 150 are formed. Each component of the second blocking member 160 is identical to that of the first blocking member 150 described above in detail, and thus a detailed description thereof is omitted.

Referring to FIG. 4, the second blocking member 160 may further include a sixth color layer 165 on the third color layer 161 and the fourth color layer 162. More specifically, the third color layer 161 may be disposed on the second insulating layer 130, the fourth color layer 162 may be disposed on the third color layer 161, and the sixth color layer 165 may be disposed on the fourth color layer 162. In addition, the third color layer 161, the fourth color layer 162 and the sixth color layer 165 of the second blocking member 160 illustrated in FIG. 4 may be stacked to have different colors from each other. In an exemplary embodiment, for example, if the third color layer 161 is blue, the fourth color layer 162 may be red, and the sixth color layer 165 may be green. In an exemplary embodiment of manufacturing the LCD 10, the sixth color layer 165 may also be formed at the same time as the color filter 140 as described above.

Referring to FIG. 5, the second blocking member 160 may not include the second light-blocking part 163 and the second spacer 164 and include only the third color layer 161 and the fourth color layer 162. If the second light-blocking part 163 and the second spacer 164 of the second blocking member 160 are omitted as described above, a process of forming the second light-blocking part 163 and the second spacer 164 can be omitted as compared with the embodiment of FIG. 3. In an exemplary embodiment of manufacturing the LCD 10, omitting processes for forming the second light-blocking part 163 and the second spacer 164 can reduce the process cost.

Like the color filter 140 in the active area AA, each color layer 151, 152, 161 or 162 of the first blocking member 150 and the second blocking member 160 in the non-active area NAA may be formed using a printing method such as an inkjet printing method. Therefore, each color layer 151, 152, 161 or 162 may have an uneven top surface.

In each of the first blocking member 150 and the second blocking member 160 according to the illustrated exemplary embodiment, a dam (including the first through fourth color layers 151, 152, 161 and 162) and a column spacer together with a light-blocking member are placed to overlap each other. Since this overlapping stacked structure is disposed a relatively small distance from the active area AA, an overall width of a bezel of the LCD 10 can be slimmed. Additionally, since this overlapped stacked structure defines an increased step height with respect to a surface on which an alignment solution is applied, overflowing of the alignment solution disposed in the active area AA and spreading of the overflowed alignment solution to the sealing member 400 may be reduced or effectively, thereby improving the adhesion of the sealing member 400 with respect to the display substrates 100 and 200. In addition, since the first through fourth color layers 151, 152, 162 and 162 of the first blocking member 150 and the second blocking member 160 in the non-active area NAA are formed using a printing method when the color filter 140 is formed in the active area AA, the first through fourth color layers 151, 152, 161 and 162 functioning as dams can be formed without a mask.

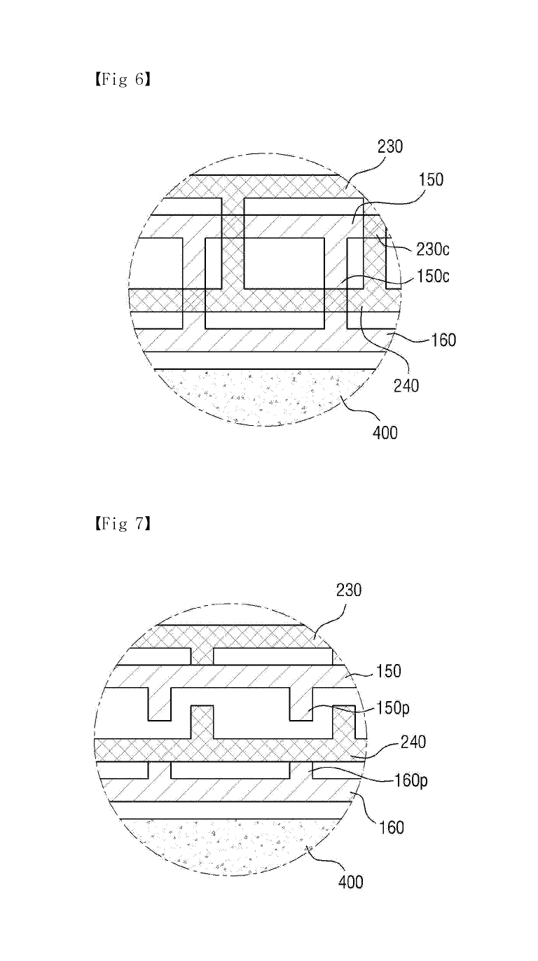

As illustrated in FIG. 2, each of the first blocking member 150 and the second blocking member 160 may be shaped like a bar that surrounds the active area AA when seen from above (e.g., the top plan view). Lengths of the first blocking member 150 and the second blocking member 160 having widths perpendicular to the lengths thereof may extend along respective sides of the LCD 10 to define the bar shape. The first blocking member 150 and the second blocking member 160 Accordingly, in a direction from the active area AA to the non-active area NAA, some alignment solution that may flow over the first blocking member 150 can be blocked by the second blocking member 160. However, each of the first blocking member 150 and the second blocking member 160 is not limited to the bar shape illustrated in FIG. 2 and can have various shapes. This will be described in greater detail later with reference to FIGS. 6 through 8.

Referring again to FIGS. 2 through 5, the third insulating layer 170 may be disposed on the second insulating layer 130 in the active area AA and the non-active area NAA and cover the color filter 140, the first and second color layers 151 and 152 of the first blocking member 150, and the third and fourth color layers 161 and 162 of the second blocking member 160. The third insulating layer 170 may be disposed as a planarization layer in the active area AA where an upper surface thereof is substantially a same distance from the first base substrate 110. An upper surface of the third insulating layer 170 may be disposed higher in the non-active area NAA than in the active area AA due to an underlying height to which the first and second color layers 151 and 152 of the first blocking member 150 and the third and fourth color layers 161 and 162 of the second blocking member 160 are stacked. In other words, when seen in cross section, portions of the third insulating layer 170 which correspond to areas in which the first blocking member 150 and the second blocking member 160 are disposed may be convex. In the active area AA, the third insulating layer 170, like the second insulating layer 130, may include a contact hole defined therein which exposes the drain electrode DE. The third insulating layer 170 may include or be made of an insulating material such as an organic insulating material.

The pixel electrode 180 may be placed to correspond to a pixel area PA in the active area AA of the first base substrate 110. The pixel electrode 180 may be electrically connected to the drain electrode DE at the contact holes defined in the second insulating layer 130 and the third insulating layer 170. The pixel electrode 180 may form an electric field together with a common electrode 220 disposed in the second display substrate 200, thereby controlling the alignment direction of the liquid crystal molecules of the liquid crystal layer 300. The pixel electrode 180 may include or be made of a transparent conductive material, for example, any one of indium tin oxide (“ITO”), indium zinc oxide (“IZO”), and indium tin zinc oxide (“ITZO”).

The first alignment layer 190 may cover the active area AA of the first base substrate 110, more specifically, the pixel electrode 180. The first alignment layer 190 initially aligns the liquid crystal molecules of the liquid crystal layer 300. In some exemplary embodiments, the first alignment layer 190 may also cover a top surface of the first blocking member 150 in the non-active area NAA due to the spreading of the alignment solution from the active area AA during manufacturing of the LCD 10. In an exemplary embodiment of manufacturing the LCD 10, the first alignment layer 190 can also be formed after the blocking member 150 and the second blocking member 160 are formed. The first alignment layer 190 may include or be made of an organic polymer material, for example, at least one of polyimide, polyamic acid and polysiloxane.

The second display substrate 200 may include a second base substrate 210, the common electrode 220, the third blocking member 230, the fourth blocking member 240 and a second alignment layer 250.

Referring to FIG. 2, for example, the second base substrate 210 may include the active area AA and the non-active area NAA defined in the second display substrate 200. In a top plan view, the second base substrate 210 may be smaller in size than the first base substrate 110. Accordingly, the second base substrate 210 may cover the active area AA of the first base substrate 110 and expose a portion of the non-active area NAA of the first base substrate 110. Like the first base substrate 110, the second base substrate 210 may include or be made of an insulating material such as transparent glass, quartz, ceramic, silicon or transparent plastic. In some exemplary embodiments, the second base substrate 210 may include or be made of a flexible material.

The common electrode 220 may be disposed on the whole surface of the second base substrate 210 in the active area AA and the non-active area NAA. The common electrode 220 may include or be made of a transparent conductive material, for example, any one of ITO, IZO and ITZO.

The third blocking member 230 may be disposed on the second base substrate 210 in a region of the non-active area NAA which is closest to the active area AA. Specifically, when seen from above (e.g., the top plan view), the third blocking member 230 may be disposed in the non-active area NAA between the active area AA and the first blocking member 150. In an exemplary embodiment of manufacturing the LCD 10, when the second alignment layer 250 is formed from an alignment solution disposed on the common electrode 220 using a printing method such as an inkjet printing method, the third blocking member 230 can reduce the spreading of the alignment solution ejected onto the common electrode 220 in the active area AA toward the sealing member 400 in the non-active area NAA. Unlike the first blocking member 150 and the second blocking member 160 disposed on the first base substrate 110, the third blocking member 230 may include only one color layer. In addition, unlike the color layers 151, 152, 161 and 162 of the first and second blocking members 150 and 160, the third blocking member 230 may be formed using a patterning process, but the invention is not limited thereto.

The fourth blocking member 240 may be disposed on the second base substrate 210 in the non-active area NAA between the active area AA and the sealing member 400. Specifically, when seen from above, the fourth blocking member 240 may be disposed in the non-active area NAA between the first blocking member 150 and the second blocking member 160. In an exemplary embodiment of manufacturing the LCD 10, when the second alignment layer 250 is formed from an alignment solution disposed on the common electrode 220 using a printing method such as an inkjet printing method, a portion of the alignment solution ejected onto the common electrode 220 in the active area AA may flow over the third blocking member 230 in the non-active area NAA. Here, the fourth blocking member 240 in the non-active area can reduce the further spreading of the alignment solution, which flowed over the third blocking member 230, toward the sealing member 400. Like the third blocking member 230, the fourth blocking member 240 may be formed using a patterning process, but the invention is not limited thereto. The fourth blocking member 240 may be formed at the same time as the third blocking member 230 and may include a same material as the third blocking member 230.

When seen from above (e.g., the top plan view), each of the third blocking member 230 and the fourth blocking member 240 may be shaped like a bar as illustrated in FIG. 2. However, the shape of each of the third blocking member 230 and the fourth blocking member 240 is not limited to the bar shape.

The second alignment layer 250 may cover the active area AA of the second base substrate 210, specifically, the common electrode 220 of the active area AA. Like the first alignment layer 190, the second alignment layer 250 may initially align the liquid crystal molecules of the liquid crystal layer 300 and may include or be made of an organic polymer material, for example, at least one of polyimide, polyamic acid, and polysiloxane.

FIGS. 6 through 8 are enlarged top plan views of exemplary embodiments of area ‘A’ of FIG. 2 according to the invention.

First, referring to FIG. 6, a first blocking member 150 and a second blocking member 160 may each collectively form a ladder shape. Like the first blocking member 150 and the second blocking member 160, a third blocking member 230 and a fourth blocking member 240 may each collectively form a ladder shape. More specifically, each of the first blocking member 150 and the second blocking member 160 may define a bar-shaped member as illustrated in FIG. 2. The first blocking member 150 and/or the second blocking member 160 may additionally define a first connecting member 150c provided in plural and which lengthwise extends in a width direction of the bar-shaped member to connect the bar-shaped member portions of the first and second blocking members 150 and 160 to each other. When seen from above, the first blocking member 150 and the second blocking member 160 are each connected by the first connecting members 150c. However, in cross section, the first connecting member 150c of is not distinguishable from the first blocking member 150 and the second blocking member 160 since these members are formed integrally with each other.

Similar to that described above for the first connecting member 150c, the first blocking member 150 and the second blocking member 160, the bar-shaped members of the third blocking member 230 and the fourth blocking member 240 may be connected to each other by a second connecting member 230c provided in plural in the top plan view. The lower blocking member defined by the first connecting member 150c, the first blocking member 150 and the second blocking member 160 overlaps the upper blocking member defined by the second connecting member 230c, the third blocking member 230 and the fourth blocking member 240.

Referring to FIG. 7, each of a first blocking member 150 and a second blocking member 160 may include a bar-shaped member and protrusions 150p or 160p respectively extended from the bar-shaped member. Here, the protrusions 150p of the first blocking member 150 may be disposed at locations corresponding to those of the protrusions 160p of the second blocking member 160. Likewise, each of a third blocking member 230 and a fourth blocking member 240 may have protrusions (not labeled). Along a length of the bar-shaped members, the protrusions 150p and 160p of the first and second blocking members 150 and 160 may alternate with the protrusions of the third and fourth blocking members 230 and 240.

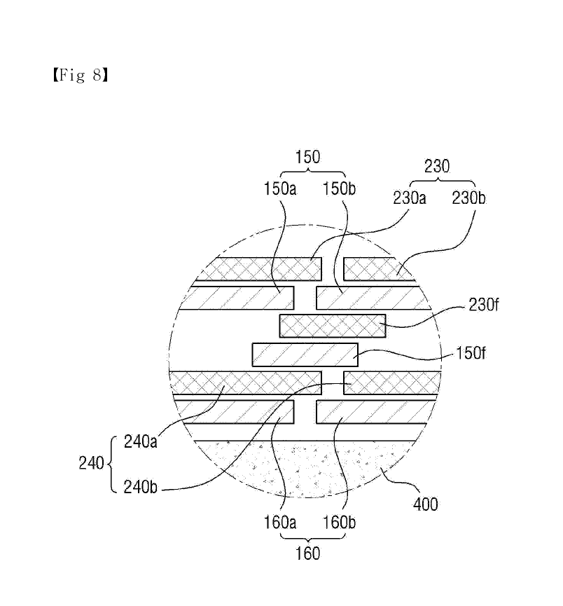

Referring to FIG. 8, each of a first blocking member 150 and a second blocking member 160 may be defined in a broken-line shape. The broken-line shape may be defined by a bar-shaped portion (e.g., sub-blocking member) provided in plural separated from each other along respective lengths of the first and second blocking members 150 and 160. The bar-shaped portions of the first blocking member 150 may define a space therebetween at a location corresponding to a location at which the bar-shaped portions of the second blocking member 160 define a space therebetween.

More specifically, the first blocking member 150 may include a plurality of first sub-blocking members 150a and 150b in the top plan view. The first sub-blocking members 150a and 150b may be separated from each other along a length of the first blocking member 150 by a predetermined gap. The second blocking member 160 may also include a plurality of second sub-blocking members 160a and 160b in the top plan view. The second sub-blocking members 160a and 160b may be separated from each other along a length of the second blocking member 160 by a predetermined gap. Here, the gap between the first sub-blocking members 150a and 150b adjacent to each other may be equal to the gap between the second sub-blocking members 160a and 160b adjacent to each other and may be disposed at a location corresponding to that of the gap between the second sub-blocking members 160a and 160b.

A third sub-blocking member 150f in a same layer as the first and second blocking members 150 and 160 may further be disposed between the first blocking member 150 and the second blocking member 160. The third sub-blocking member 150f may be provided in plural. The third sub-blocking member 150f may be disposed at a location corresponding to the location of the gap between the first sub-blocking members 150a and 150b or the location of the gap between the second sub-blocking members 160a and 160b. A lower blocking member may be collectively defined by the first sub-blocking members 150a and 150b, the second sub-blocking members 160a and 160b and the third sub-blocking members 150f.

In a width direction of the light blocking members 150 and 160, that is, in a direction from the active area AA to the non-active area NAA, the gaps between the first sub-blocking members 150a and 150b are not aligned with the location of the gaps between the second sub-blocking members 160a and 160b.

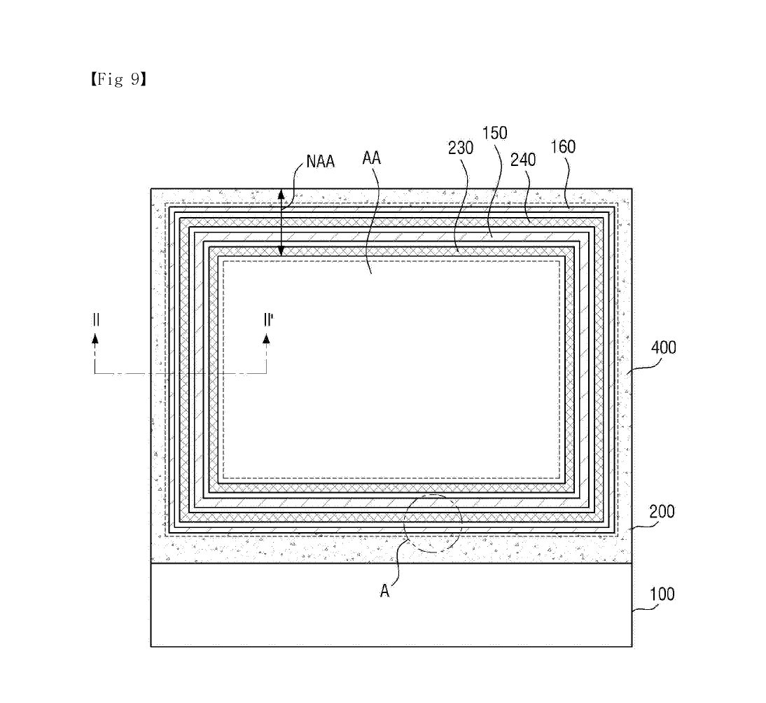

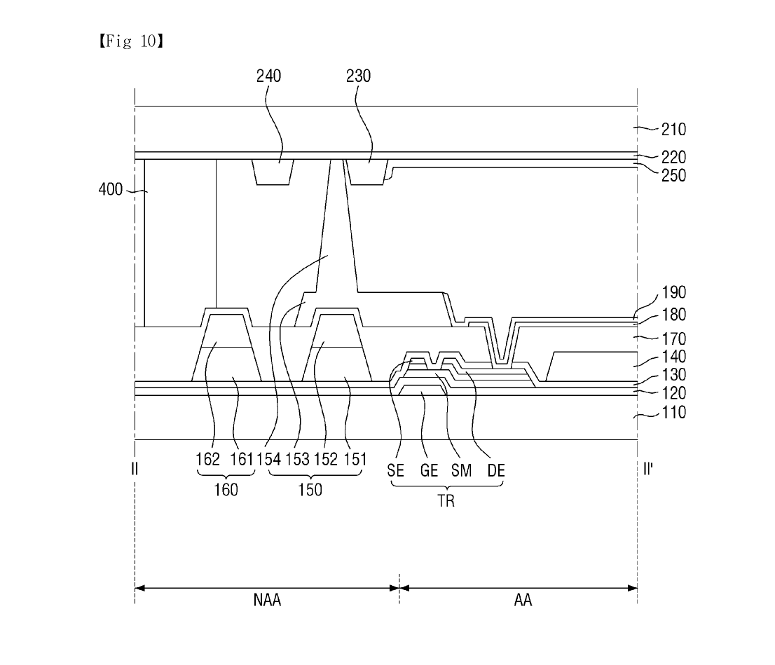

FIG. 9 is a schematic top plan view of yet another exemplary embodiment of an LCD according to the invention. FIG. 10 is a cross-sectional view taken along line II-II′ of FIG. 9.

Referring to FIGS. 9 and 10, in the LCD according to the illustrated exemplary embodiment, a second blocking member 160 disposed on a non-active area NAA of a first substrate 100 may partially overlap a sealing member 400. Here, the second blocking member 160 does not include a second light-blocking part 163 and a second spacer 164 (refer to FIGS. 3 and 4). The LCD according to the illustrated exemplary embodiment of FIGS. 9 and 10 is identical to the LCD 10 of FIGS. 2 through 8 except for the above components, and thus a detailed description thereof is omitted.

What is claimed is:

1. A liquid crystal display comprising:
a first substrate comprising an active area in which an image is displayed and a non-active area which is disposed around the active area and in which an image is not displayed;
a color filter on the first substrate and in the active area thereof;
a first blocking member on the first substrate in the non-active area thereof; and
a first alignment layer on the color filter and in the active area,
wherein the first blocking member comprises:
a first color layer in the non-active area;
a first light-blocking part on the first color layer and overlapping the first color layer; and
a first spacer on the first light-blocking part and overlapping the first color layer and the first light-blocking part.

2. The liquid crystal display of claim 1, wherein the first color layer is defined by a stack of color layers having different colors from each other.

3. The liquid crystal display of claim 2, wherein the first color layer in the non-active area and the color filter in the active area are in a same layer among layers disposed on the first substrate.

4. The liquid crystal display of claim 1, further comprising a second blocking member on the first substrate and in the active area thereof, the second blocking member spaced apart from the first blocking member in the non-active area.

5. The liquid crystal display of claim 4, wherein the second blocking member comprises:
a second color layer in the non-active area;
a second light-blocking part on the second color layer and overlapping the second color layer; and
a second spacer on the second light-blocking part and overlapping the second color layer and the second light-blocking part.

6. The liquid crystal display of claim 5, wherein the second color layer is defined by a stack of color layers having different colors from each other.

7. The liquid crystal display of claim 6, wherein the second color layer in the non-active area is in a same layer as the color filter in the active area and the first color layer in the non-active area.

8. The liquid crystal display of claim 4, wherein
the second blocking member comprises a second color layer in the non-active area, and
the second color layer is defined by a stack of color layers having different colors from each other.

9. The liquid crystal display of claim 4, wherein in a top plan view, the first blocking member and the second blocking member in the non-active area of the first substrate have a bar shape, a bar shape from which protrusions extend, a broken line shape or a ladder shape.

10. The liquid crystal display of claim 4, further comprising:
a second substrate facing the first alignment layer on the first substrate, the second substrate comprising an active area and a non-active area respectively corresponding to the active area and the non-active area of the first substrate;
a third blocking member on the second substrate and in the non-active area thereof; and
a second alignment layer on the second substrate and in the active area thereof.

11. The liquid crystal display of claim 10, wherein the third blocking member comprises a third color layer which is in the non-active area of the second substrate and adjacent to the active area of the second substrate and has one color.

12. The liquid crystal display of claim 10, further comprising a fourth blocking member on the second substrate and in the non-active area thereof, the fourth blocking member spaced apart from the third blocking member in the non-active area of the second substrate.

13. The liquid crystal display of claim 12, wherein the fourth blocking member comprises a fourth color layer having one color.

14. The liquid crystal display of claim 12, wherein in a top plan view, the third blocking member and the fourth blocking member in the non-active area of the second substrate have a bar shape, a bar shape from which protrusions extend, a broken line shape or a ladder shape.

15. The liquid crystal display of claim 12, wherein
the first blocking member and the second blocking member in the non-active area of the first substrate are disposed opposite to the third blocking member and the fourth blocking member in the non-active area of the second substrate, and
in a direction from the active area to the non-active area in a top plan view, the third blocking member is placed to correspond to an area between the first blocking member and the second blocking member.

16. The liquid crystal display of claim 10, further comprising a sealing member which bonds the first substrate and the second substrate together,
wherein the sealing member is disposed on the first substrate or the second substrate in the active area thereof.

17. The liquid crystal display of claim 16, wherein in a direction from the active area to the non-active area in a top plan view, the first blocking member and the second blocking member are each disposed between the active area of the first substrate and the sealing member.

18. The liquid crystal display of claim 17, wherein among the first and second blocking members, the second blocking member is disposed closer to the sealing member than the first blocking member.

19. The liquid crystal display of claim 17, wherein the second blocking member partially overlaps the sealing member.
